(19) United States
(12) Patent Application Publication
(10) Pub. No.: US 2007/0174738 A1
(43) Pub. Date: Jul. 26, 2007

(54) Disk device, method of writing data in disk device, and computer product

(75) Inventor: Osamu Yoshida, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/377,482

(22) Filed: Mar. 16, 2006

(30) Foreign Application Priority Data
Dec. 26, 2005 (JP) 2005-373328

(51) Int. Cl. G06F 11/00

(52) U.S. Cl. 714/54; 714/5

(57) ABSTRACT

A disk device includes a buffer memory and a temporary memory. The temporary memory temporarily stores packet data received from a higher-level device. The capacity of the temporary memory is equal to or larger than a maximum size of packet data that can be received from the higher-level device. It is decides whether the packet data present in the temporary memory includes an error, the packet data is transferred from the temporary memory to the buffer memory only if there is no error in the packet data.

### BACKGROUND OF THE INVENTION

1. Field of the Invention

The present invention relates to a technology for preventing data loss in a buffer memory of a disk device.

2. Description of the Related Art

Disk devices including a serial interface such as a serial AT attachment (ATA) are typically provided with a write cache function to enhance access performance. Specifically, write data received from a higher-level device is temporarily input to a buffer memory in the disk device, and a write completion notification is issued to the higher-level device at this stage. Subsequently, at a predetermined timing, the data accumulated in the buffer memory is written into a disk medium.

In such disk devices, when a write error occurs while writing the data accumulated in the buffer memory into the disk medium, data remaining in the buffer memory, which is not yet written into the disk medium, needs to be relieved.

In a disk device disclosed in Japanese Patent Application Laid Open No. H2-64815, when a write error occurs, subsequent writing processing is suspended. Subsequently, when another instruction to write data into the disk medium is received from the higher-level device, error information is notified to the higher-level device. Upon receiving a restart command notified by the higher-level device according to the error information, the disk device resumes the suspended write processing.

In the conventional disk device including the write cache function, when the data received from the higher-level device to be written into the buffer memory has a common write address with data that is already accumulated in the buffer memory, the data already accumulated in the buffer memory at the common write address is overwritten by the data received from the higher-level device.

Accordingly, the data to be written over the data in the common write address, and data in front of and after the data of the common write address can be allocated continuously in the order of the write address. Thus, the disk device can efficiently write data accumulated in the buffer memory into the disk medium.

However, errors in the disk device including write cache function are mainly write errors that occur when data accumulated in the buffer memory is written into the disk medium, and communication errors that occur at the interface when data is input from the higher-level device.

In the disk device including the serial interface, data received from the higher-level device is sent in units of packet data including data in a plurality of sector units. The packet data includes cyclic redundancy check (CRC) data generated based on contents of the packet data before being transferred to the disk device. The disk device can check whether a communication error has occurred at the interface by comparing the CRC data before being transferred and CRC data generated based on contents of the packet data after being transferred.

When a communication error is detected in the data, the disk device requests the higher-level device to the data once again. However, sometimes the correct data sent again cannot be received properly because of a communication error at the interface.

Under such circumstance, when the data already stored in the buffer memory is overwritten by new data with the common address, the correct data already stored is overwritten and erased by the error data.

### SUMMARY OF THE INVENTION

It is an object of the present invention to at least solve the problems in the conventional technology.

According to an aspect of the present invention, a disk device connected to a higher-level device via a serial interface and that writes packet data received from the higher-level device on a disk medium, includes a buffer memory configured to store therein data; a temporary memory that temporarily stores packet data received from the higher-level device, a capacity of the temporary memory being equal to or larger than a maximum size of packet data that can be received from the higher-level device; a deciding unit that decides whether the packet data present in the temporary memory includes an error; and a transferring unit that transfers the packet data from the temporary memory to the buffer memory upon the deciding unit deciding that there is no error in the packet data.

According to another aspect of the present invention, a method of writing packet data received from the higher-level device on a disk medium with a disk device, the disk device including a buffer memory configured to store therein data, includes temporarily storing packet data received from the higher-level device into a temporary memory, a capacity of the temporary memory being equal to or larger than a maximum size of packet data that can be received from the higher-level device; deciding whether the packet data present in the temporary memory includes an error; and transferring the packet data from the temporary memory to the buffer memory upon deciding at the deciding that there is no error in the packet data.

According to still another aspect of the present invention, a computer-readable recording medium stores therein a computer program that implements the above method on a computer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a disk device according to an embodiment of the present invention;

FIG. 2 is a block diagram of a host-interface control unit shown in FIG. 1; and

FIG. 3 is a flowchart of an error check processing performed by the host-interface control unit.

### DETAILED DESCRIPTION OF THE PREFERRED EMBODIMENTS

Exemplary embodiments of the present invention will be described below with reference to accompanying drawings. The present invention is not limited to these embodiments.

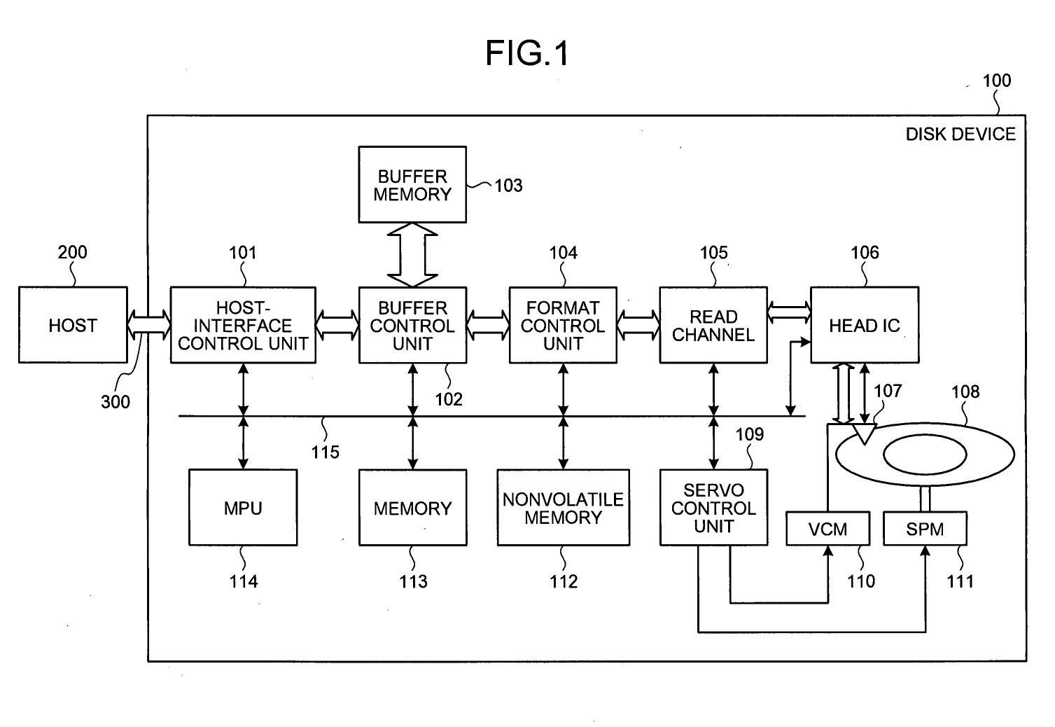

FIG. 1 is a block diagram of a disk device 100 according to an embodiment of the present invention. The disk device 100 is a magnetic disk device. The disk device 100 is connected to a host 200 (higher-level device) through a host interface 300. The host 200 is, for example, a personal computer. The host interface 300 can be a serial ATA interface, for example.

The disk device 100 includes a host-interface control unit 101, a buffer control unit 102, a buffer memory 103, a format control unit 104, a read channel 105, a head integrated circuit (IC) 106, a head 107, a disk medium 108, a servo control unit 109, a voice coil motor (VCM) 110, a spindle motor (SPM) 111, a nonvolatile memory 112, a memory 113, and a microprocessor (MPU) 114.

The host-interface control unit 101, the buffer control unit 102, the format control unit 104, the read channel 105 the head IC 106, the servo control unit 109, the nonvolatile memory 112, the memory 113, and the MPU 114 are connected through a common bus 115.

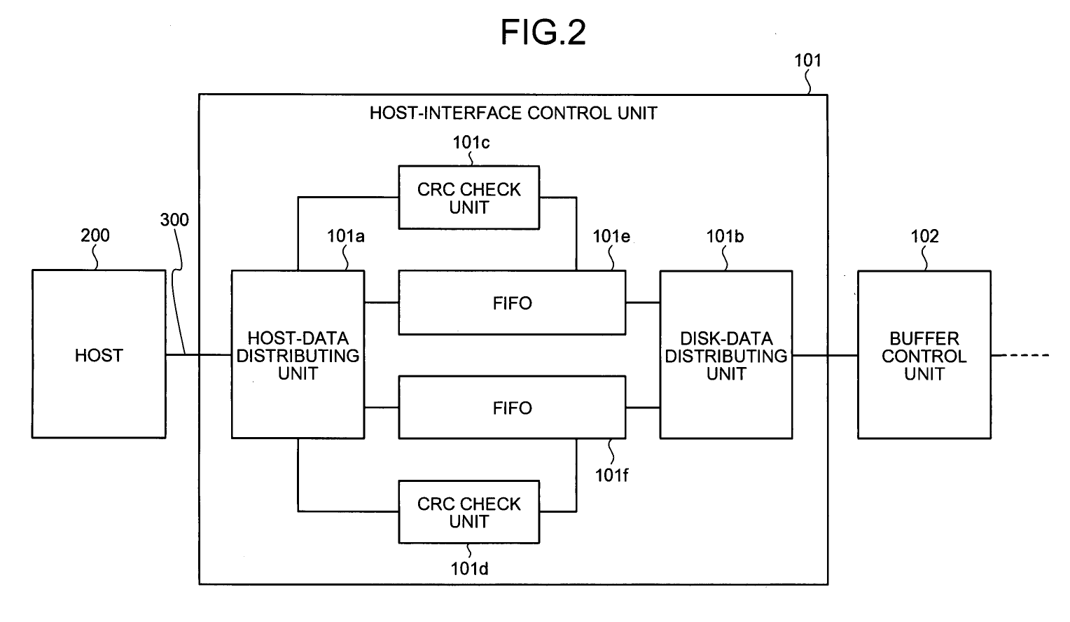

The host-interface control unit 101 controls input and output of data exchanged between the disk device 100 and the host 200 through the host interface 300. FIG. 2 is a block diagram of the host-interface control unit 101. The host-interface control unit 101 includes a host-data distributing unit 101a, a disk-data distributing unit 101b, a CRC check unit 101c, a CRC check unit 101d, a first-in first-out (FIFO) 101e, and a FIFO 101f.

The data transferred from the host 200 through the host interface 300 is transferred in units of packet data including a plurality of sector units. The maximum size of one packet data is prescribed as 8,192 bytes. Each packet data includes CRC data used for detecting an error in the data. The CRC data is generated by a calculation according to a CRC method based on contents of the packet data to be transferred.

The host-data distributing unit 101a controls data transfer between the host 200, the FIFO 101e, and the FIFO 101f. Specifically, in a write operation, the host-data distributing unit 101a alternately distributes packet data received from the host 200 to the FIFO 101e and the FIFO 101f. At the same time, the host-data distributing unit 101a transfers the packet data distributed to the FIFO 101e to the CRC check unit 101c, and transfers the packet data distributed to the FIFO 101f to the CRC check unit 101d.

The CRC check unit 101c and the CRC check unit 101d check whether an error has occurred in the respective transferred packet data. When an error is detected, the host-data distributing unit 101a requests the host 200 to resend the corresponding data.

In a read operation, the host-data distributing unit 101a receives data from the FIFO 101e and the FIFO 101f, and sequentially transfers the received data to the host 200 through the host interface 300.

The disk-data distributing unit 101b controls data transfer between the buffer control unit 102, the FIFO 10le, and the FIFO 101f. Specifically, in a write operation, the disk-data distributing unit 101b receives data from the FIFO 101e and the FIFO 101f, and sequentially transfers the received data to the buffer control unit 102. In a read operation, the disk-data distributing unit 101b alternately distributes data received from the buffer control unit 102 to the FIFO 101e and the FIFO 101f in units of data as received.

The CRC check unit 101c and the CRC check unit 101d are integrated circuits (IC) that check whether an error has occurred in data transferred from the host-data distributing unit 101a. Specifically, the CRC check unit 101c and the CRC check unit 101d generates new CRC data based on received packet data, compares the new CRC data with CRC data already included in the packet data, and checks whether they match.

When they match, the CRC check unit 101c and the CRC check unit 101d determine that an error did not occur in the packet data, and the CRC check unit 101c sends a transfer permission signal to the FIFO 101e, and the CRC check unit 101d sends a transfer permission signal to the FIFO 101f.

On the other hand, if they do not match, the CRC check unit 101c and the CRC check unit 101d determine that an error occurred in the packet data, and the CRC check unit 101c sends a transfer prohibition signal to the FIFO 101e, and the CRC check unit 101d sends a transfer prohibition signal to the FIFO 101f. At the same time, the CRC check unit 101c and the CRC check unit 101d informs the host-data distributing unit 101a that error data is detected.

The CRC check unit 101c and the CRC check unit 101d check whether packet data received from the host 200 includes an error based on CRC data included in the packet data, and therefore, an error can be detected at a higher precision compared to a parity check or a check sum.

The FIFO 101e and the FIFO 101f are queues that accumulate data exchanged between the host 200 and the disk device 100. The size of each of the FIFO 101e and the FIFO 101f is prescribed to store at least one packet data, i.e., 8,192 bytes or more. The FIFO 101e and the FIFO 101f sequentially accumulates data exchanged between the host 200 and the disk device 100, and sequentially transfers data from data stored first according to statuses of the host 200 and the disk device 100.

In a write operation, the FIFO 101e and the FIFO 101f determine whether to send data to the disk-data distributing unit 101b according to a transfer permission signal or a transfer prohibition signal received from the CRC check unit 101c and the CRC check unit 101d, respectively.

The host-interface control unit 101 includes the two FIFOs 101e, 101f, alternately registers packet data received from the host 200 to the FIFOs 101e, 101f, and transfers packet data from both the FIFOs 101e, 101f to the buffer memory 103 in parallel. Accordingly, while processing packet data stored in one of the queues, packet data subsequently received from a higher-level device can be processed in another queue, so that processing speed is prevented from decreasing due to an error check.

Two FIFOs are included in this case; however, more than two FIFOs can be included to process more than two packet data in parallel, so that processing speed is further prevented from decreasing due to an error check.

Referring back to FIG. 1, the buffer control unit 102 controls input and output of data to and from the buffer memory 103. Specifically, in a write operation, the buffer control unit 102 stores write data transferred from the host-interface control unit 101 in the buffer memory 103, and issues a write completion notification. The write completion notification issued is sent to the host 200 through the host-interface control unit 101 and the host interface 300.

The buffer control unit 102 takes out the data accumulated in the buffer memory 103 at a predetermined timing (for example, when the buffer memory 103 is full), and transfers the data to the format control unit 104. The data transferred to the format control unit 104 is then sent to the head 107 through the read channel 105 and the head IC 106, and written in a specified write address in the disk medium 108.

In a read operation, the buffer control unit 102 takes out data corresponding to a read address specified by the host 200 from the buffer memory 103, and transfers the data to the host 200 through the host-interface control unit 101. When the data corresponding to the specified read address is not stored in the buffer memory 103, the buffer control unit 102 instructs the format control unit 104 to read the corresponding data from the disk medium, temporarily stores the data in the buffer memory 103, and then transfers the data to the host 200.

The buffer memory 103 temporarily stores write data received from the host 200 or read data read from the disk medium 108, and buffers a difference in a communication speed between the host 200 and the disk device 100 (fast) and a speed of reading from/writing in the disk medium 108 (slow).

The format control unit 104 controls writing and reading data to and from the disk medium 108. Specifically, the format control unit 104 stores correspondences between data stored in the buffer memory 103 and data stored in the disk medium 108, and controls a write operation so that data is efficiently allocated in the disk medium 108. In a read operation, the format control unit 104 transfers data read from the disk medium 108 to the buffer control unit 102.

In a write operation, the read channel 105 encodes data to be written in the disk medium 108, and transfers the data from the format control unit 104 to the head IC 106. In a read operation, the read channel 105 decodes the data read from the disk medium 108, and transfers the data from the head IC 106 to the format control unit 104.

In a write operation, the head IC 106 modulates data that the head 107 is to write in the disk medium 108, and in a read operation, the head IC 106 demodulates data that the head 107 read from the disk medium 108.

The disk medium 108 is a magnetic disk that stores data input and output between the host 200 and the disk device 100. The head 107 is a magnetic head that writes data in the disk medium 108 and reads data from the disk medium 108.

The servo control unit 109 controls operations of the VCM 110 and the SPM 111. The VCM 110 is a motor that moves the head 107 to a target position on the disk medium 108, and the SPM 111 is a motor that rotates the disk medium 108.

The nonvolatile memory 112 is a read-only memory (ROM) that stores control programs for controlling the disk device 100, and the memory 113 is a random access memory (RAM) that stores intermediate execution results of control programs and data used for control. The MPU 114 controls all units in the disk device 100 by reading control programs from the nonvolatile memory 112 and executing them.

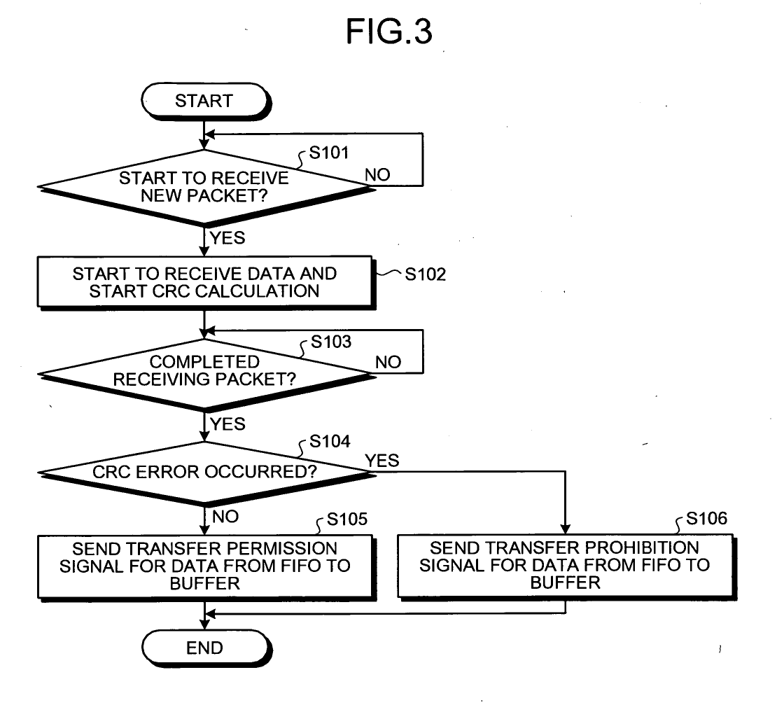

FIG. 3 is a flowchart of an error check processing performed in the host-interface control unit 101. The host-data distributing unit 101a receives new packet data from the host 200 (Yes at step S101).

When a packet data is detected, the host-data distributing unit 101a alternately stores packet data into the FIFO 101e and the FIFO 101f. In this example, packet data is stored in the FIFO 101e. The host-data distributing unit 101a stores the received packet data in the FIFO 101e, and simultaneously sends the same data to the CRC check unit 101c (when the packet data is stored in the FIFO 101f, the packet data is simultaneously sent to the CRC check unit 101d). The CRC check unit 101c performs CRC calculation based on the data received, and generates CRC data (step S102).

When one packet data is stored in the FIFO 101e (Yes at step S103), the CRC check unit 101c compares the generated CRC data and CRC data already included in the received packet data, and checks whether they match. When they match, the CRC check unit 101c determines that an error has not occurred in the packet data (No at step S104), and sends a transfer permission signal to the FIFO 101e (step S105). When the transfer permission signal is received, the FIFO 101 e transfers the packet data stored to the disk-data distributing unit 101b.

When the generated CRC data and CRC data already included in the received packet data do not match, the CRC check unit 101c determines that an error has occurred in the packet data (Yes at step S104), sends a transfer prohibition signal to the FIFO 101e, and notifies the host-data distributing unit 101a that error data is detected (step S106). When the notification is received, the host-data distributing unit 101a requests the host 200 to resend the same data as the error data.

The CRC check unit 101c and the CRC check unit 101d checks, based on CRC data, whether an error has occurred in packet data stored in the FIFO 101e and the FIFO 101f, respectively, and stores packet data in the buffer memory 103 only when an error is not detected. Thus, data loss in the buffer memory 103, which is caused by overwriting correct data with error data, is prevented, so that reliability of the disk device 100 is improved.

Two FIFOs are included in the embodiment, however, one FIFO is also sufficient, as data loss in the buffer memory 103 can be prevented by controlling storage of data in the buffer memory 103 in packet data units, so that an error can be checked by CRC data.

According to the present embodiment, the host-interface control unit 101 includes the FIFO 101e and the FIFO 101f, each having a size of the maximum data size of packet data received from the host 200, the CRC check unit 101c and the CRC check unit 101d check data received from the host 200 in packet data units, and transfers packet data from the FIFO 101e and the FIFO 101f to the buffer memory 103 only when an error is not detected. Thus, data loss in the buffer memory 103, which is caused by overwriting correct data with error data, is prevented, so that reliability of the disk device 100 is improved.

The magnetic disc device is described in the embodiment; however, the present invention is not limited thereto, and can be similarly applied to an optical disk device and a magnet-optical disk device.

According to an aspect of the present invention, data loss in a buffer memory, which is caused by overwriting correct data with error data, is prevented, so that reliability of the disk device is improved.

Furthermore, processing speed in a disk device is prevented from decreasing due to checking an error in packet data, and data loss in a buffer memory, which is caused by overwriting correct data with error data, is prevented, so that reliability of the disk device is improved.

Moreover, an error can be detected at a higher precision compared to a parity check or a check sum, and data loss in a buffer memory, which is caused by overwriting correct data with error data, is prevented, so that reliability of the disk device is improved.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A disk device connected to a higher-level device via a serial interface and that writes packet data received from the higher-level device on a disk medium, the disk device comprising:
a buffer memory configured to store therein data;
a temporary memory that temporarily stores packet data received from the higher-level device, a capacity of the temporary memory being equal to or larger than a maximum size of packet data that can be received from the higher-level device;
a deciding unit that decides whether the packet data present in the temporary memory includes an error; and
a transferring unit that transfers the packet data from the temporary memory to the buffer memory upon the deciding unit deciding that there is no error in the packet data.

2. The disk device according to claim 1, further comprising a plurality of temporary memories that sequentially stores therein packet data received from the higher-level device, wherein
the transferring unit transfers the packet data present in the temporary memories to the buffer memory in parallel.

3. The disk device according to claim 1, further comprising two temporary memories that alternately store therein packet data received from the higher-level device, wherein
the transferring unit transfers the packet data present in the temporary memories to the buffer memory in parallel.

4. The disk device according to claim 1, wherein
the packet data includes cyclic-redundancy-check data, and
the deciding unit decides whether the packet data includes an error based on the cyclic-redundancy-check data.

5. The disk device according to claim 1, further comprising a writing unit that writes the packet present in the buffer memory onto the disk medium.

6. The disk device according to claim 1, wherein the temporary memory is a first-in first-out (FIFO) memory.

7. A method of writing packet data received from the higher-level device on a disk medium with a disk device, the disk device including a buffer memory configured to store therein data, the method comprising:
temporarily storing packet data received from the higher-level device into a temporary memory, a capacity of the temporary memory being equal to or larger than a maximum size of packet data that can be received from the higher-level device;
deciding whether the packet data present in the temporary memory includes an error; and
transferring the packet data from the temporary memory to the buffer memory upon deciding at the deciding that there is no error in the packet data.

8. The method according to claim 7, wherein temporarily storing includes temporarily and sequentially storing the packet data received from the higher-level device into a plurality of temporary memories, wherein
the transferring includes transferring the packet data present in the temporary memories to the buffer memory in parallel.

9. The method according to claim 7, wherein temporarily storing includes temporarily and sequentially storing the packet data received from the higher-level device into two temporary memories, wherein
the transferring includes transferring the packet data present in the temporary memories to the buffer memory in parallel.

10. The method according to claim 7, wherein
the packet data includes cyclic-redundancy-check data, and
the deciding includes deciding whether the packet data includes an error based on the cyclic-redundancy-check data.

11. The method according to claim 7, further comprising writing the packet present in the buffer memory onto the disk medium.

12. The method according to claim 7, wherein the temporary memory is a first-in first-out (FIFO) memory.

13. A computer-readable recording medium that stores therein a computer program that implements on a computer a method of writing packet data received from the higher-level device on a disk medium with a disk device, the disk device including a buffer memory configured to store therein data, the computer program causing the computer to execute:
temporarily storing packet data received from the higher-level device into a temporary memory, a capacity of the temporary memory being equal to or larger than a maximum size of packet data that can be received from the higher-level device;
deciding whether the packet data present in the temporary memory includes an error; and
transferring the packet data from the temporary memory to the buffer memory upon deciding at the deciding that there is no error in the packet data.
